(19) United States
(12) Patent Application Publication
(10) Pub. No.: US 2018/0290329 A1
(43) Pub. Date: Oct. 11, 2018

(54) CHAIN SAW AND METHOD FOR CONTROLLING MOVEMENTS OF GUIDE BAR THEREIN

(71) Applicant: Ponsse Oyj, Vieremä (FI)

(72) Inventors: Markku HUTTUNEN, Iisalmi (FI); Toni KOHIO, Kuopio (FI); Tero KAATRASALO, Iisalmi (FI); Martin GARCIA, Montecaseros (UY)

(73) Assignee: Ponsse Oyj, Vieremä (FI)

(21) Appl. No.: 15/764,144

(22) PCT Filed: Sep. 28, 2016
(86) PCT No.: PCT/FI2016/050676

§ 371 Date: Mar. 28, 2018

(30) Foreign Application Priority Data
Sep. 30, 2015 (FI) 20155692

(51) Int. Cl. B27B 17/02; A01G 23/091; B27B 17/12; B27B 17/14

(52) U.S. Cl. CPC B27B 17/02; B27B 17/14; B27B 17/12; A01G 23/091

(57) ABSTRACT

The present disclosure relates to a chain saw of a wood handling device and to controlling the guide bar in it. The guide bar is attached to a turning frame rotatably arranged to a frame of the chain saw through a fastening arrangement. The fastening arrangement of the guide bar and the turning frame are joined by at least one guide for controlling the guide bar during movement along its longitudinal axis. The guide includes opposite slide guides with opposite sliding and mating surfaces that form a form-locking joint joining the fastening arrangement and turning frame together. This type of separate slide guide arranged in the chain saw is movable in at least one direction differing from the direction of travel allowed by the guide, which makes it possible to modify clearance between the sliding surface and mating surface.

### BACKGROUND OF THE INVENTION

The invention relates to a chain saw in accordance with the preamble of claim 1. The present invention also relates to a method in accordance with the preamble of claim 12 for controlling the movements of a guide bar in the chain saw.

In mechanical logging, the feeling and cutting of a tree is generally performed by a motorized sawing device, a chain saw, at the harvester head of a forest machine. A similar chain saw can also be used in a so-called chopping machine that makes firewood, for instance. In addition, a corresponding chain saw for cutting wood material can be arranged in various logging waste balers, fuel wood balers or other balers and packing devices, in which case the chain saw can be used to cut several trunks and/or branches at a time, the cutting of the wood must be earned out quickly and reliably, so, for mechanical wood handling, some of the most critical parts are the chain saw and its reliable operation.

At least periodically, it is necessary to tighten the saw chain of a chain saw, because the saw chain stretches during operation due-to heating and dynamical factors, among other things. In the chain saws of logging machines, such as harvesters or processors, automatic chain tighteners are often used, which in forest machine environments in particular are usually hydraulic, though other tightening methods are also known. Said chain tightener usually moves the guide bar in the direction of its longitudinal axis, whereby the movement is arranged to take place on specific support guides or surfaces. As a result of the movement of the guide bar, the saw chain tightens around the guide bar and the drive sprocket controlling the saw chain.

Numerous different solutions of chain saw chain tighteners are known. One chain saw chain tightener used in forest machines is known from publication FI115706. The publication describes a chain saw, in which, for the purpose of tightening the saw chain, the guide bar is arranged to be movable in the direction of its longitudinal axis via at least one support guide. The support guide is arranged to extend in the direction of the longitudinal axis of the guide bar on both sides of the drive sprocket, which provides a well-supported movement in the direction of the longitudinal axis.

A solution according to publication FI101772 is also known, which is a saw assembly comprising a block element fastened to a fastening piece of the guide bar. A gap or groove which serves as a fixed slide guide is formed between the inner surfaces of the pieces of the block element. First and second piston-cylinder elements are arranged to bear against the blade holder for the purpose of fixing a blade attachment in place without clearances.

Publication WO2015038011 is also known, in which the guide bar is arranged slidingly to the saw frame with fixed slide guides. The arrangement comprises a stretch detector of the saw chain that contains a length sensor of the tightening motion and its electronic control system.

However, the prior art still has unsolved problems. One of the greatest problems is the wear of the sliding surfaces and the related parts of a chain tightener in the chain saws of forest machines. The wear of the sliding surfaces of components causes clearances in the chain saw, which hamper the control of the blade flange and may damage the saw chain and other moving parts in a sawing device.

The wear of the chain tightener parts of a chain saw requires that the parts be replaced at intervals that depend on the use and conditions. Replacing worn parts requires maintenance breaks and interruption in work.

In addition, in the prior art, the clearances due to wear in the parts often lead to lubrication oil leakage through the larger clearances out of the structure and into the environment. Leaking lubrication oil, in turn, causes both an increase in costs due to increased consumption of lubrication oil and an environmental load.

### SUMMARY OF THE INVENTION

It is an object of the invention to develop a method and an apparatus implementing the method in such a manner that the abovementioned problems are solved.

The object of the invention is achieved by a method and system which are characterised by what is disclosed in independent claims 1 and 12.

Preferred embodiments of the invention are disclosed in the dependent claims.

The essential idea of the invention is based on making the slide guides in the support guides connecting the chain saw frame and guide bar fastening system or at least part of the sliding surfaces of the slide guides wearable. By connecting the slide guides by an adjustable arrangement to the support guide, it is possible to adjust the clearances caused by wear between the support guide sliding surfaces and guide in a simple manner during use.

An adjustable arrangement for the fastening of the slide guides makes it possible to adjust the clearances as desired. Thus, the clearance can also be increased or even closed entirely when necessary. If the clearance is closed entirely, it is even possible to look the fastening arrangement of the guide bar manually to be completely stationary in relation to the chain saw frame.

With the solution of the invention, the slide guides of the support guide can be manufactured of separate, wearing and easily replaceable components. When the parts are worn enough, these wearing parts can easily be replaced by new ones instead of having to replace the entire fastening arrangement or even the entire chain saw frame.

By utilizing the adjustable slide guides of the invention, the need for maintenance in the chain saw is reduced and simplified. The adjustment of the clearance is fast and the worn components are easily replaceable by new ones without having to dismantle the entire sawing device. As downtime due to maintenance thus decreases, the work efficiency of the chain saw increases. In addition, according to the invention, the wearing components are replaceable by new ones in a significantly advantageous manner in comparison with the prior art.

Other advantages provided by the invention are disclosed in the following more detailed description of specific embodiments of the invention.

### LIST OF FIGURES

In the following, some preferred embodiments of the invention will be explained in more detail and with reference to the accompanying drawing, in which

FIG. 1 is a conceptual view of a forest machine with its harvester head,

FIG. 2 shows a harvester head used in a forest machine with its chain saw,

FIG. 3 is an axonometric view of a chain saw used in a harvester head,

FIG. 4 shows a guide bar of a prior-art chain saw with its fastening arrangement and support guides,

FIG. 5 is an exploded view of the guide bar of the chain saw according to the invention with its fastening arrangement and support guide,

FIG. 6 is a schematic view of a support guide between the chain saw frame and guide bar fastening arrangement,

FIG. 7 shows a detail of item A in FIG. 6,

FIG. 8 shows another embodiment of the detail of item A in FIG. 6,

FIG. 9 is a sectional detail of item A in FIG. 8 with the slide guide detached,

FIG. 10 shows the slide guides of the support guide between the chain saw frame and guide bar fastening arrangement, and

FIG. 11 shows another alternative of the slide guides of the support guide between the chain saw frame and guide bar fastening arrangement.

### DETAILED DESCRIPTION OF PREFERRED EMBODIMENTS

The present figures do not show the chain saw and method for controlling the movement of the guide bar in scale, but the figures are schematic and illustrate the structure and operation of the preferred embodiments in principle. The structural parts shown by reference numbers in the attached figures then correspond to the structural parts marked by reference numbers in this specification.

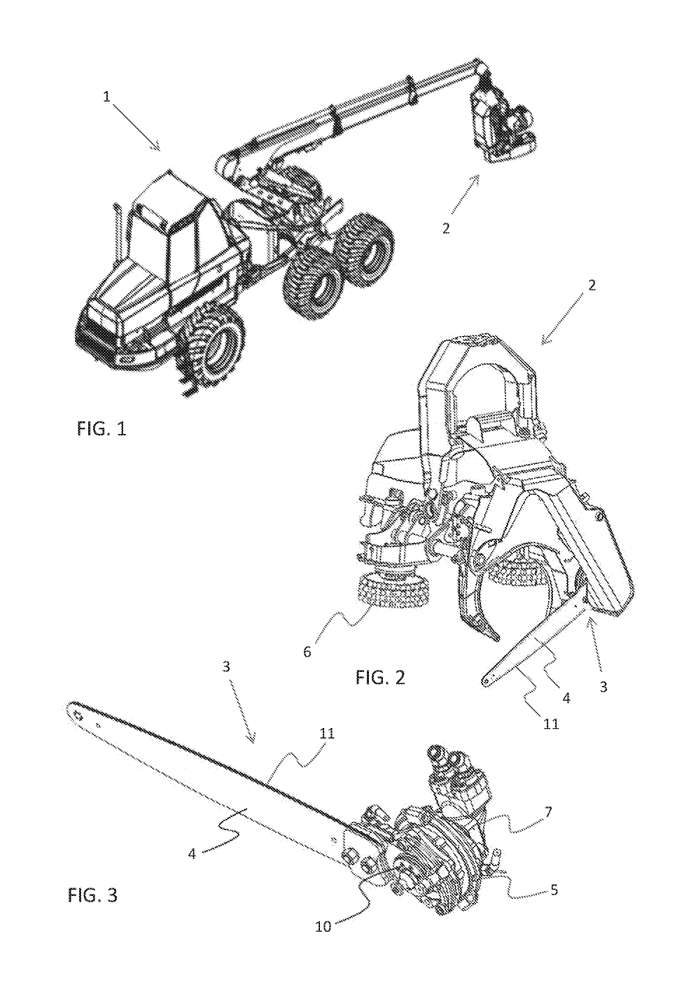

Thus, FIG. 1 shows a typical forest machine 1, in which the present chain saw is used, for example. The forest machine comprises a harvester head 2 supported by a boom, or a similar wood handling, device. The harvester head is shown in more detail in FIG. 2. Thus, this type of harvester head comprises said chain saw 3 for cutting trees. The chain saw has a saw chain rotating around the guide bar 4, the guide bar being arranged to turn in relation to the chain saw frame 6. When the cutting head holds a tree between feed rollers 6, the guide bar can be turned and the tree held by the feed rollers can be cut at the intended location.

FIG. 3 shows an embodiment of the chain saw 3 with its power unit 7 and detached from the harvester head 2. However, the figures do not show the saw chain rotating around the guide bar 4 and having a generally known structure and operational principle.

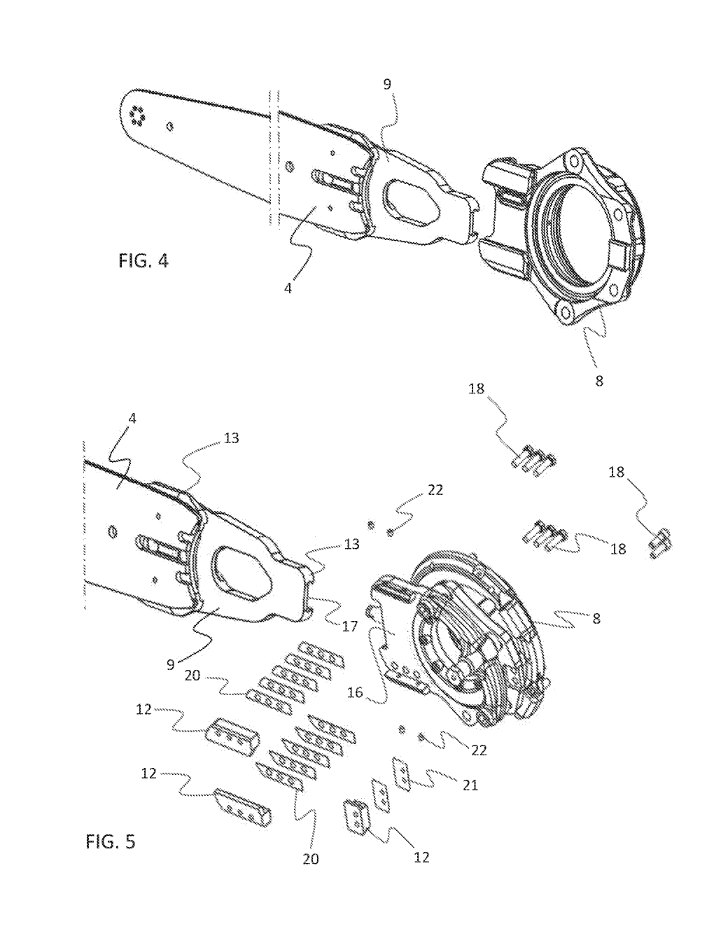

FIG. 4 further shows a prior-art arrangement for tightening the saw chain in a chain saw 3. It is, thus, a chain saw for a forest machine 1, wherein the arrangement comprises, among other things, a turning frame 8 rotatably joined to the chain saw frame 5 and a guide bar 4 for controlling the saw chain. The figure also shows a part of a tightening device of the saw chain. Said tightening device thus comprises, among other things, a guide bar 4 fastening arrangement 9, to which the guide bar is fastened. The fastening arrangement is arranged slidingly through the turning frame to the chain saw frame. This way, the guide bar with its fastening arrangement is arranged to be movable in the direction of the longitudinal axis of the guide bar for tightening the saw chain.

The chain saw 3 is driven by a power source 7, a motor that rotates the saw chain around the guide bar 4 through power transmission controlled by a drive sprocket 10, for instance (see FIG. 3). The power source of the chain saw is preferably pressure medium-operated, for instance hydraulic, and is preferably the power source of the forest machine 1 or coupled to it. During sawing, the saw chain rotates around the guide bar 4, whereby its movement is preferably controlled by a chain idler at the outer end of the guide bar. To avoid, loosening during operation, the chain saw is also equipped with the above-mentioned specific saw chain tightening device.

Even though the present solution is described with reference to a chain saw 3 in a forest machine 1, the utilization of the solution is not limited to this operating environment only. Thus, the solution can also be utilized in other wood handling units, in which the chain saw may be arranged to fee turnable during the cutting movement. On the other hand, the cutting movement can also be implemented by using the chain saw as a parallel cross-cut saw, or the tree being felled may be arranged to be pressed against a stationary chain guide bar and the saw chain rotating around it.

FIG. 5 shows one of the preferred embodiments of the present solution. The solution comprises a chain saw 3 having, at least in accordance with FIG. 3, a power unit 7, a drive sprocket 10 controlled by the power unit, and a saw chain rotated along the outer circumference 11 of its guide bar 4. The guide bar is attached to a turning frame 8 rotatably arranged to a frame 5 on the chain saw through a specific fastening arrangement 9. Furthermore, a tightening device is arranged to affect the fastening arrangement, with which tightening device a movement is provided in the guide bar which is in the direction of its longitudinal axis and distances it from the drive sprocket, for the purpose of tightening the saw chain.

The tightening device comprises at least one transfer element arranged in the turning frame 8 and producing a movement substantially in the direction of the longitudinal axis of the guide bar 4. This transfer element is, in turn, arranged to act on a counter-piece in the guide bar or its fastening arrangement 9. When the fastening device of the guide bar and the turning frame are joined by at least on support guide, the transfer element provides a movement substantially in the direction of the longitudinal axis of the guide bar. Even though the movement of the transfer element providing the tightening movement of the saw chain was not fully in the direction of the longitudinal axis of the guide ban the transfer element is arrangeable to provide a movement in the direction of the tightening movement.

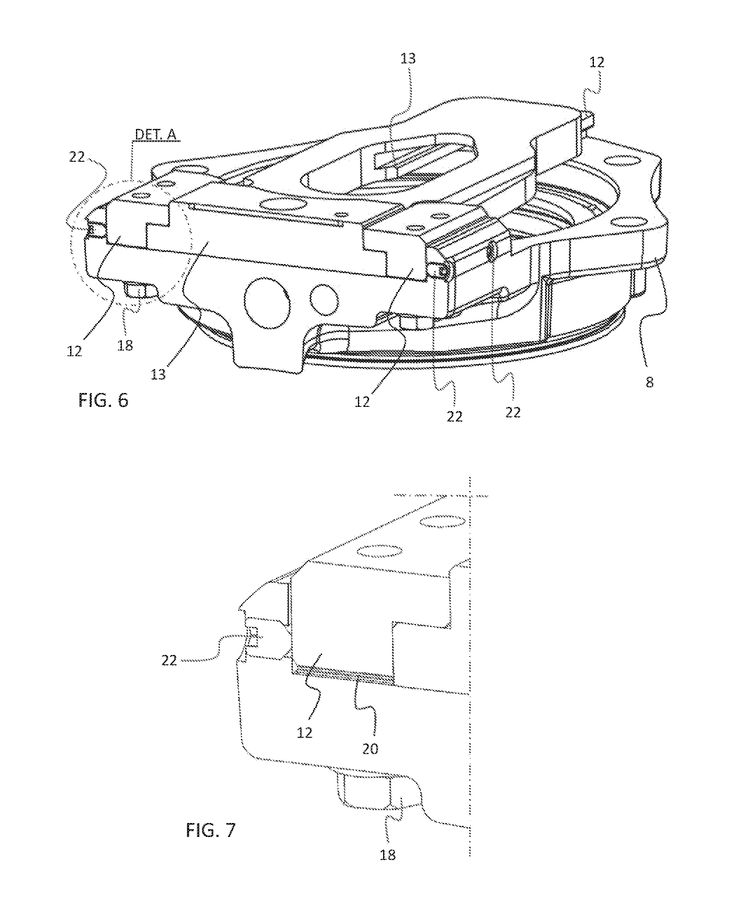

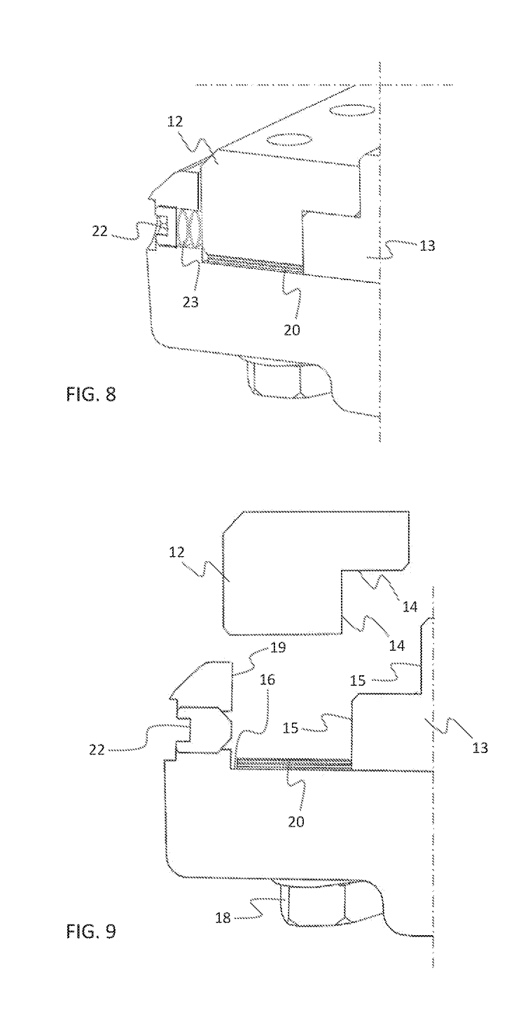

The support guide of the present chain saw 3 comprises a guide equipped with guide surfaces allowing a movement in the direction of the longitudinal axis of the guide bar 4. This type of guide is formed of specific slide guides 12 and 13 that together with the turning frame 8 and frame structures of the fastening arrangement 9 provide a form-lock structure. The slide guides comprise sliding and mating surfaces 14 and 15 in the direction of the tightening movement, see FIG. 9. The slide guide surfaces that settle against each other are arranged to form a path for the tightening movement. The sliding surfaces comprise parallel sliding and mating surfaces that settle against each other. These make possible a form-locking path, under the guidance of which the fastening arrangement 9 slides controlled by the transfer element, in a preferred embodiment, the sliding and mating surfaces are arranged in pairs, and there are at least two pairs. There may be one or more of these interactive slide guide pairs forming a guide in a chain saw. To achieve sufficient structural strength, it is preferable to utilize one long guide or two shorter guides. The present embodiment has two guides, i.e. in the direction of travel of the guide bar 4, one on both sides of the drive sprocket 10. In FIG. 6, it is possible to distinguish the first slide guides 12 between the drive sprocket and guide bar. A second slide guide 13 that moves in relation to the first slide guides and in the longitudinal direction of the guide bar and forms part of the guide is arranged between the above. In the figure, it is also possible to distinguish, on the opposite side of the drive sprocket, one of the second slide guides 13 that will settle on both sides of the first slide guide 12 that is shown more clearly in FIG. 8, for instance.

In the embodiments shown in the figures, the guide parts on the turning frame are referred to as the first slide guides 12. The guide parts in the fastening arrangement are, in turn, referred to as the second slide guides 13. This structure can also be implemented as a mirror image, in which case the first slide guides are in the fastening arrangement and the second slide guides are in the turning frame.

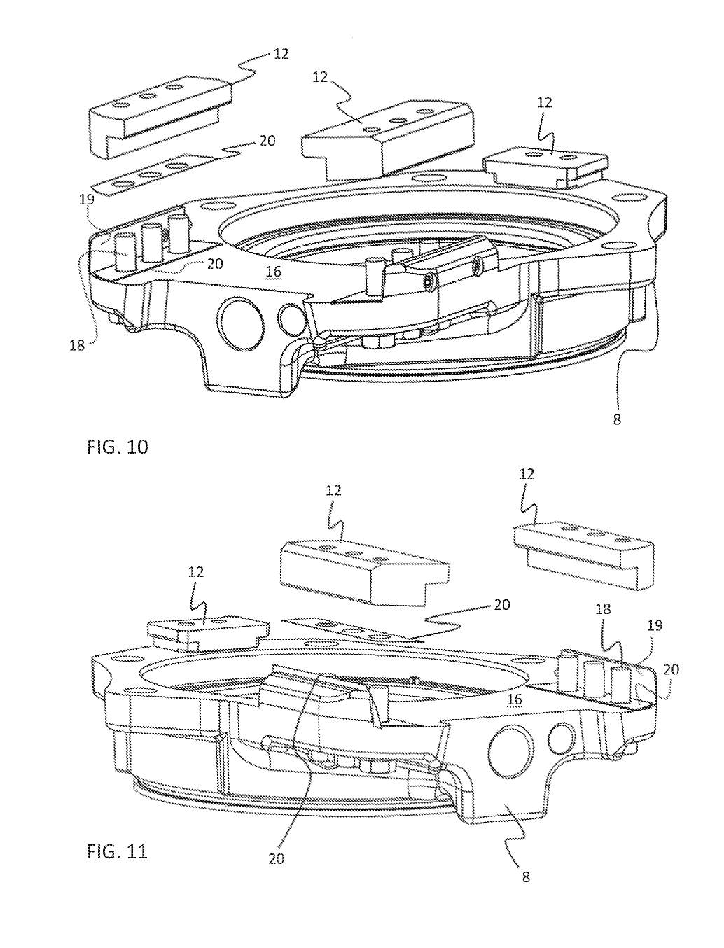

The slide guides 12 and 13 according to a specific embodiment are formed of at least partly separate means that settle against each other and are preferably arrangeable against mounting surfaces 16 or 17 in the chain saw 3. Thus, the slide guide can be fastened by mechanical joining means 18 to a mounting surface that is preferably parallel to the outer surface of the guide bar, see FIGS. 10 and 11, for instance. On the other hand, the slide guide may be fastened to a support surface 19 that is parallel to the direction of travel of the guide bar 4, but perpendicular to its outer surface. The slide guide may also be formed by a fixed means machined to the fastening arrangement or turning frame, as shown in FIG. 8.

The slide guides 12 and 13 can, thus, be equipped with specific sliding and mating surfaces 14 and 15 arranged to settle against each other for the purpose of controlling the movement of the guide bar 4. In this connection, these surfaces are referred to in such a manner that the first slide guides 12 have the sliding surfaces 14 and the second slide guides 13 have the mating surfaces 15.

According to what is stated above, some of the slide guides 12 and 13 are arrangeable to be means arranged separately to the chain saw by joining means 18. In the present embodiment, especially the first slide guides 12 shown in FIGS. 5, 10 and 11 are of this type. The clearance between the sliding surface 14 of the first slide guide and the mating surface 15 of the second slide guide can then be arranged to be separately adjustable. This type of adjustability is achieved in such a manner that one or more slide guides are arranged to be movable to adjust the clearance or distance between the sliding and mating surfaces. Preferably, the slide guide is then movable in at least one direction that differs from the direction of travel allowed by the guide. Preferably, this transfer movement of the slide guide is arranged to take place in at least one direction that is perpendicular to the direction of travel allowed by the guide, for instance in the direction of the normal of the sliding and mating surfaces that are substantially against each other. Then again, the slide guide can be made movable in some other direction depending on the cross-sectional geometry of the guide. The transfer of the slide guide is arranged to be performed by separate adjustment means 20 or 21.

At its simplest; the distance of the slide guide 12 and/or 13 is adjusted by one or more shims 20 arranged between the slide guide and the abutting mounting surface 16 or 17 or support surface 19. FIG. 5, for instance, shows an embodiment. In which two or five shims are mounted between the slide guide 12 and mounting surface 16. Shims of this type may be equal, partly equal or completely different m thickness. The shim can also be mounted between the slide guide and support surface 19, see FIG. 11. In an embodiment, the shim can be mounted both between the slide guide and mounting surface and between the slide guide and support surface, see FIG. 11.

As the clearance between the sliding surfaces 14 and mating surfaces 15 of the slide guides 12 and 13 grows, a sufficiently controlled transfer movement of the guide bar 4 becomes more difficult. By removing one or more shims 20, it is again possible to achieve a correct clearance between the sliding and mating surfaces.

In addition to the above-mentioned shims 20, it is also possible to adjust the distance between the sliding and mating surfaces 14 and 15 by specific adjusting screws 22. These are mounted to act on the position of the slide guide in relation to the mounting surface 16, 17 or support surface 19 or both. FIGS. 8 and 7 show a structure of such an arrangement. Adjusting screws 22 that penetrate the support surface 19 then act on the first slide guide 12 arranged by mechanical joining means 18 to the mounting surface 18. These produce a transfer movement in the direction of the mounting surface of the slide guide, in which the first slide guide 12 either pulls away from the second slide guide 13 shown in the figure or approaches the second slide guide. To produce the movement, the mechanical joining means of the slide guide allow its sideways displacement in relation to the direction of travel of the guide bar 4. As can be seen in FIG. 7, both adjusting screws 22 and shims 20 are preferably combined in adjusting the slide guide. However, the adjustment can also be done by adjusting the distance between the first slide guide and the second slide guide by means of adjusting screws that are arranged on the first slide guide and act on the support surface 19 abutting it. The operation of the adjusting screw, in particular, can be improved by arranging a spring element 23 to the adjustment means it forms. This type of embodiment is shown in FIG. 8.

The slide guide of the support guide that has a mating surface and is generally an integral part of the fastening arrangement is preferably made of or coated with a wear-resistant material. This may be steel or hard metal or a ceramic material. The slide guide having a sliding surface is, in turn, preferably made of or coated with a wearing material that is softer than that of the second slide guide abutting it, preferably a bronze alloy, brass or a suitable polymer.

In accordance with the present FIGS. 5 to 11, the support guide can also be implemented in such a manner that the first slide guide 12, which is equipped with sliding surfaces 14 in the direction of the longitudinal axis of the guide bar 4, comprises one separate means arranged against the mounting surface in the chain saw. This first slide guide is preferably arranged by mechanical joining means 18 to a mounting surface 18 that is parallel to the outer surface of the guide bar, see FIGS. 10 and 11, for instance. This first slide guide is, as described above, in interaction with the second slide guide pair 13 that partially surrounds it for the purpose of achieving a form-lock structure. Such concurrent and mainly parallel second slide guides form, together with their mating surfaces 15 oriented toward the first slide guide and the surface of the chain saw defined between them, the path of the guide.

If necessary, in the solution according to this second embodiment, it is also possible to arrange that the clearance between the sliding and mating surfaces 14 and 15 of the slide guides be adjustable. The adjustability is then achieved in such a manner that the position of the first slide guide 12 is arranged to be movable in a direction perpendicular to the mounting surface 16. At its simplest, the distance of the first slide guide is adjusted by one or more shims 21 arranged between the slide guide and the abutting mounting surface. Shims of this type may be equal, partly equal or completely different in thickness.

An alternative to the use of the above-mentioned shims 21 is to adjust the distance of the first slide guide 12 from the mounting surface 16 by using specific adjusting screws. These are mounted to act on the position of the first slide guide in relation to the mounting surface. Adjusting screws that penetrate the mounting surface then act on the first slide guide arranged by the mechanical joining means 18 to the mounting surface. These produce a transfer movement to the first slide guide, in which the first slide guide either pulls away from the mounting surface or approaches it.

Because the arrangement and adjustment method described above can be utilized in the harvester head of a chain saw in a wood handling device, it is similarly advantageous to arrange to this chain saw a conduit, through which lubrication agent can, as necessary, also be fed to the guide to lubricate it. This type of conduit can, for instance, be arranged to extend to one or more sliding surfaces of the guide.

A person skilled in the art will find it obvious that, as technology advances, the basic idea of the invention may be implemented in various ways. The invention and its embodiments are thus not restricted to the above examples but may vary within the scope of the claims.

1. A chain saw of a wood handling device, comprising;
at least a power unit;
a drive sprocket driven by the power unit;
a guide bar; and
a saw chain rotated by the drive sprocket along an outer circumference on the guide bar, wherein
the guide bar is attached to a turning frame in the chain saw through a fastening arrangement;
the turning frame being arranged rotatably to the frame of the chain saw for turning the guide bar on a plane defined by the guide bar;
the fastening arrangement of the guide bar having a tightening device arranged thereto, which is arranged to control the-movement of the guide bar in a direction of its longitudinal axis in relation to the drive sprocket;
the fastening arrangement of the guide bar and turning frame being joined by at least one guide for controlling the guide bar during a movement in the direction of its longitudinal axis;
the guide having opposite slide guides that form a form-locking joint joining the fastening arrangement and turning frame together in such a manner that each slide guide in the turning frame has a sliding surface and each slide guide oriented against it includes a mating surface, at least one of the slide guides being formed of a separate means arranged in the chain saw; wherein:
the slide guide is arranged to be movable in at least one direction differing from the direction of travel allowed by the guide for modifying a clearance between the sliding surface and mating surface; and
such a transfer movement of the slide guide is achieved by one or more adjustment means arranged to act on the slide guide.

2. A chain saw of a wood handling device as claimed in claim 1, wherein the transfer movement of the slide guide is arranged to take place in a direction that is perpendicular to the direction of travel allowed by the guide, a direction of a normal of the sliding and mating surfaces that are substantially against each other.

3. A chain saw of a wood handling device as claimed in claim 2, wherein a distance between the sliding surface and mating surface of the slide guides is arranged to be adjustable by at least one shim arranged between the slide guide and the mounting surface and/or support surface abutting it.

4. A chain saw of a wood handling device as claimed in claim 1, wherein a distance between the sliding surface and mating surface of the slide guides is arranged to be adjustable by adjusting screws acting on the slide guide through a mounting surface and/or support surface abutting it.

5. A chain saw of a wood handling device as claimed in claim 1, comprising:
adjusting screws, wherein the distance between the sliding surface and mating surface of the slide guides is arranged to be adjustable by the adjusting screws acting on the mounting surface and/or support surface abutting the slide guide, and the adjusting screws being arranged in the slide guide.

6. A chain saw of a wood handling device as claimed in claim 4, wherein the adjustment means comprises:
a spring element.

7. A chain saw of a wood handling device as claimed in claim 1, wherein:
the slide guide with the mating surface is made of a wear-resistant material, which includes at least one of steel or hard metal or a ceramic material; and
alternatively, the mating surface of the slide guide is coated by a wear-resistant material, which includes at least one of steel hard metal or a ceramic material.

8. A chain saw of a wood handling device as claimed in claim 1, wherein:
the slide guide with the sliding surface is made of a wearing material that is softer than the slide guide with the mating surface, which includes at least one of a bronze alloy, brass or polymer;
alternatively, the sliding surface is coated with a wearing material, which includes at least one of a bronze alloy, brass or polymer,

9. A chain saw a wood handling device as claimed in claim 1, wherein the chain saw comprises:
a conduit for feeding lubrication agent to the guide to lubricate it, the conduit being arranged in connection with the sliding surface of the support guide.

10. A forest machine comprising:
a harvester head; and
a chain saw of a wood handling device in the harvester head, the chain saw including:
at least a power unit;
a drive sprocket driven by the power unit;
a guide bar; and
a saw chain rotated by the drive sprocket along an outer circumference on the guide bar, wherein
the guide bar attached to a tuning frame on the chain saw through a fastening arrangement, and
the turning frame being arranged rotatably to the frame of the chain saw for turning the guide bar on a plane defined by the guide bar;
the fastening arrangement of the guide bar having a tightening device arranged thereto, which is arranged to control movement of the guide bar in a direction of its longitudinal axis in relation to the drive sprocket;
the fastening arrangement of the guide bar and turning frame being joined by at least one guide for controlling the guide bar during a movement in the direction of its longitudinal axis;
the guide having opposite slide guides that form a form-locking joint joining the fastening arrangement and tuning frame together in such a manner that each slide guide in the turning frame has a sliding surface and each slide guide oriented against it includes a mating surface, at least one of the slide guides being formed of a separate means arranged in the chain saw; wherein:
the slide guide is arranged to be movable in at least one direction differing from the direction of travel allowed by the guide for modifying a clearance between the sliding surface and mating surface; and
such a transfer movement of the slide guide is achieved by one or more adjustment means arranged to act on the slide guide.

11. A method for controlling a guide bar in a chain saw of a wood handling device, the chain saw having at least a power unit, a drive sprocket driven by the power unit, a guide bar, and a saw chain rotated by the drive sprocket along the outer circumference on the guide bar, wherein;
the guide bar is attached to a turning frame in the chain saw through a fastening arrangement in the guide bar, and the turning frame allows a relative rotational motion of the chain saw frame and guide bar on a plane defined by the guide bar, and in such a manner that:
the fastening arrangement and turning frame are joined by at least one guide to achieve a movement in a direction of a longitudinal axis of the guide bar; which
guide provides a form-locked joint, in which each slide guide in the turning frame includes a sliding surface and each slide guide of the fastening arrangement oriented against it includes a mating surface;
a tightening device acts on the fastening arrangement of the guide bar to control movement of the guide bar in the direction of its longitudinal axis; and
at least one of the slide guides is formed of a separate means arranged in the chain saw,
wherein the method comprises:
moving the slide guide arranged in the chain saw in a direction differing from at least one direction of travel allowed by the guide, to modify a clearance between the sliding surface and mating surface; and
achieving such a transfer movement of the slide guide by one or more adjustment means acting on the slide guide.

12. A method as claimed in claim 11, comprising:
adjusting the distance of the slide guide by installing at least one shim between the slide guide and the mounting surface and/or support surface abutting it.

13. A method as claimed in claim 11, comprising:
adjusting the distance of the slide guide is adjusted by acting on the slide guide or the mounting surface and/or support surface abutting it by adjusting screws.

14. A chain saw of a wood handling device as claimed in claim 3, wherein a distance between the sliding surface and mating surface of the slide guides is arranged to be adjustable by adjusting screws acting on the slide guide through a mounting surface and/or support surface abutting it.

15. A chain saw of a wood handling device as claimed in claim 14, comprising:
adjusting screws, wherein the distance between the sliding surface and mating surface of the slide guides is arranged to be adjustable by the adjusting screws acting on the mounting surface and/or support surface abutting the slide guide, and the adjusting screws being arranged in the slide guide.

18. A chain saw of a wood handling device as claimed in claim 15, wherein the adjustment means comprises:
a spring element.

17. A chain saw of a wood handling device as claimed in claim 16, wherein:
the slide guide with the mating surface is made of a wear-resistant material, which includes at least one of steel or hard metal or a ceramic material; and
alternatively, the mating surface of the slide guide is coated by a wear-resistant material, which includes at least one of steel, hard metal or a ceramic material.

18. A chain saw of a wood handling device as claimed in claim 17, wherein:
the slide guide with the sliding surface is made of a wearing material that is softer than the slide guide with the mating surface, which includes at least one of a bronze alloy, brass or polymer;
alternatively, the sliding surface is coated with a wearing material, which includes at least one of a bronze alloy, brass or polymer.

19. A chain saw of a wood handling device as claimed in claim 18, wherein the chain saw comprises:
a conduit for feeding lubrication agent to the guide to lubricate it, the conduit being arranged in connection with the sliding surface of the support guide.

20. A method as claimed in claim 12, comprising:
adjusting the distance of the slide guide is adjusted by acting on the slide guide or the mounting surface and/or support surface abutting it by adjusting screws.
